(19) United States
(12) Patent Application Publication
(10) Pub. No.: US 2008/0171647 A1
(43) Pub. Date: Jul. 17, 2008

(54) LOW TEMPERATURE COFIRED CERAMIC MATERIALS

(76) Inventors: Wei-Chang Lee, Tao-Yuan (TW); Yin-Chang Wu, Tao-Yuan (TW); Kuo-Shu Tseng, Tao-Yuan (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/623,926

(22) Filed: Jan. 17, 2007

(51) Int. Cl. C03C 1/00

(52) U.S. Cl. 501/32; 428/620

(57) ABSTRACT

A low temperature cofired ceramic material mainly includes that mixed evenly with high thermal conductivity ceramic materials (AlN) and Borosilicate powder glass materials.

### BACKGROUND OF THE INVENTION

1. Field of the invention

The present invention relates to a low temperature cofired ceramic (LTCC) material, particularly to a low temperature sintered AlN/glass composite material which can be formed at the temperature of 750-850° C. by using a kind of low melting point glass made of borosilicate glasses using AlN powder as the major material and is added with proper sintering aids.

2. Description of the Prior Art

Ceramic material is provided with good thermal conductivity and electrical insulation. Its chemical composition can be changed and properties can be adjusted so that it has been widely applied in electronic packaging. Ceramic material not only serves as the common substrate and lid (or cap) material, but also can be formed as a multilayer interconnection substrate by using thick film metallization technology for application of high density packaging. Since ceramic materials have high density and good resistance to molecules permeation, they become the primary materials for hermetic packaging. However, they are subjected to stress destruction due to high brittleness. Compared with plastic packaging, the process temperature and cost of ceramic packaging is higher than plastic packaging. Therefore, ceramic packaging can only be seen in the IC packaging that requires high reliability and it is no longer the most used packaging technology.

The basic process of ceramic packaging is first to bind an IC chip onto a ceramic substrate loaded with a lead or thick film metal pad. After the connection between the IC chip and substrate pad is complete, the ceramic lid and substrate can be bound by using the glass binder or alloy welding. Ceramic packaging can provide high reliability and hermetic structure due to the compact binding characteristic of ceramic, lead and glass materials.

In early stages, applications of ceramic materials into packaging can be seen in IBM's solid logic technology and monolithic system technology. Ceramic Dual Inline Packages (CerDIPs) is the earliest and presently commonest hermetic packaging technology. With the increase of IC chip sets integration, a variety of ceramic packaging such as QFP packaging and PGA packaging with or without leads have been developed. Currently, PGA packaging is the very common packaging used for CPU.

Al2O3 is the commonest ceramic packaging materials. Other materials such as BeO, SiC, glass-ceramics, and diamond are also major ceramic packaging materials.

Preparing slurry is the primary step for ceramic packaging. Slurry includes ceramic and glass powders, and binder, plasticizer, or solvent having organic compounds, which are mixed in a proper ratio.

Inorganic ceramic powder cab be divided into high temperature cofired type and low temperature cofired type. The ratio of Al2O3 to glass powder in the high temperature cofired type power is 9:1; the ratio of Al2O3 to glass powder in the low temperature cofired type power is 1:3. The type of said ceramic powder varies depending on the demand of substrate's thermal expansion coefficient. Al2O3, quartz, calcium zirconate (CaZrO3), and forsterite (Mg2SiO4) are substrate materials with high thermal expansion coefficient, while fused silica, mullite (Al6Si2O13), cordierite (Mg2Al4Si5O18), zirconia (ZrO2) are substrate materials (2) with low thermal expansion coefficient.

The common glass powder materials include calicia-magnesia-alumina silicate glass or Borosilicate glass. The purpose of adding the glass powder is to adjust the thermal expansion coefficient of ceramic materials so that the thermal expansion coefficient is close to the conductive material's thermal expansion coefficient in order to eliminate the generation of thermal stress. Since the sintering temperature of pure Al2O3 is 1900° C., another purpose of adding glass powders is to decrease the process sintering temperature and save production cost. The type of glass powders depends on the demand for substrate's dielectric constant. Moreover, the softening temperature of glass materials must be higher than the de-binder sintering temperature of organic ingredients in the slurry, but the temperature should not be too high to impede sintering. Ceramic and glass powder must be ball grinded after they were mixed together to ensure they have been uniformly mixed and proper-sized powders and distribution can be obtained. Therefore, the contractibility of said materials in the oncoming sintering process can be controlled accurately.

Binder provides temporary binding of the powders in order to facilitate the formation of green tape and other follow-up process such as thick film metallization. Binder should possess high glass transition temperature, high molecular weight, good de-binder sintering and easy to be dissolved in the volatile organic solvent. The binder frequently used with the high temperature cofired substrate is polyvinyl butyral (PVB). Other types of the binder include polyvinyl chloride acetata, polymethyl methacrylate (PMMA), polyisobutylene (PIB), polyalphamethyl styrene (PAMS), nitrocellulose, cellulose acetate, etc. In addition to PVB, the binders used by the low temperature cofired type substrate include polyacetones, copolymer of lower alkyl acrylates, methacrylates, etc. These materials can be sintered under the air or inert atmosphere the temperature of 300˜400° C. The additive amount is over the 1˜5% of the slurry's gross weight (gr. wt.). But the additive amount should not be too much for fear of increasing the sintering time and reducing the density during powder's sintering which results in the increase of the contractibility of said substrate.

Said plasticizer functions to decrease the glass transition temperature of said binder by means of plasticization and to provide the green tape with flexibility. Phthalate, phosphate, oleate, glycol ether, glyceryl mono oleate, petroleum, polyester, rosin derivatives, sabacate, and citrate can be used as said plasticizer.

Said organic solvent can function to facilitate the distribution of powders. Upon vaporization, tiny holes can be formed in the green tape, which provides the capability of compress deformation when the green tape is folded. There are a variety of organic solvents, including acetic acid, acetone, n-butyl alcohol, butyl acetate, carbon tetrachloride, cyclohexanone, diacetone alcohol, dioxane, 95% ethyl alcohol, 85% ethyl acetate, ethyl cellosolve, ethylene chloride, 95% isopropyl alcohol, isopropyl acetate, methyl alcohol, methyl acetate, methyl cellosolve, methyl ethyl ketone, methyl isobutyl ketone, pentanol, pentanone, propylene dichloride, toluene, 95% toluene ethyl alcohol, etc.

After the required inorganic and organic ingredients have been mixed together and then undergone ball grinding in a period of time, said slurry is formed. Then, a green tape in a specified shape is fabricated by using the method such as doctor blade casting, dry press, or roll compaction. After the green tape is formed as the substrate material or lid through the process of thick film metallization and sintering, it can be applied to IC chip packaging.

Ceramic green tape can be formed as the packaging materials with circuit conductor by using thick film technology. To fabricate the ceramic substrate having the multilayer interconnection circuit structure, green tape must undergo various processes such as blanking, punching, via filling, thick film metallization, and lamination, and then firing/sintering. After the processes of nickel plating, lead attach and test, the ceramic packaging materials with multilayer interconnection circuits—Al2O3 multilayer ceramic connection have been fabricated.

Due to the miniaturization of electronic devices, high output of semiconductor devices and high-speed trend of signal processing, a diversity of novel technologies and structures of microelectronic packaging appear came out. New packaging models demand higher requirement for packaging materials, including good heat conductivity, low dielectric constant and dielectric loss, thermal expansion coefficient that matches various IC chips, and good mechanical strength and machinability. At present, the largely used hermetic packaging ceramic substrate materials include Al2O3 and BeO. However, since the sintering temperature of single phase ceramic packaging materials are typically high (above 1600° C.), circuit materials are typically comprised of W and Mo. The drawback is that the resistivity of conductive materials is high which may cause great loss, and the dielectric constant of insulating materials is high which may result in too long delay time and the higher production cost. Accordingly, the attention has been focused on the low temperature cofired ceramic (LTCC) system wherein the sintering temperature usually ranges between 850° C. and 1000° C. The circuit materials should be good conductor with low resistivity such as Cu and Ag. LTCC system is comprised of Al2O3 and glass or micro-crystalline glass. However, the thermal conductivity of major ingredients in Al2O3 and glass or micro-crystalline glass is not high and usually contains about 50 wt % glass phase, so that the materials have low thermal conductivity.

### SUMMARY OF THE INVENTION

Accordingly, the present invention has been made to solve the above-mentioned problem occurring in the prior art, and an object of the present invention is to provide a novel solid state electrolyte capacitor.

The present invention provides a low temperature sintered AlN multi-phase material and its fabrication method applied in electric packaging. The low temperature sintered AlN/glass composite material is formed at the temperature of 850˜1000° C. by using AlN powder as the major material along with the Borosilicate low melting point glass and proper sintering aids added. The factors that affect sintering, heat, dielectric and mechanics properties have been systematically analyzed. The impact of AlN granular degree to heat conductivity has also been analyzed theoretically. Through the design of material composition, comprehensive properties of multi-phase materials have been improved, the material's thermal conductivity has been enhanced to 11 W/m.K, low dielectric constant 4.5-7 (room temp.: 1 MHZ) can be obtained, and the thermal expansion coefficient is controlled under 5-10×10-6/K, which can meet the requirement of high density packaging.

On the basis of the softening temperature of low melting point Borosilicate glass drew into multi-phase materials and the wetting properties of AlN powder, the present invention adopts the unique low temperature sintering technology. Under the combined action of pressure and liquid state viscous flow, the density of multi-phase materials with 50˜80wt % AlN can be achieved under the temperature of 1000° C. within 2 hours. Also, relevant technology such as tape casting and metal wiring has also been analyzed. This lays the foundation for the application of AlN/glass composite substrate materials to the low temperature cofired technology.

### BRIEF DESCRIPTION OF THE DRAWINGS

The above and other objects, features and advantages of the present invention will be more apparent from the following detailed description taken in conjunction with the accompanying drawings, in which:

FIG. 1 is the comparison of thermal conductivity coefficient between embodiment 1 and contrast 1 in the present invention;

FIG. 2 is the comparison of thermal conductivity coefficient between embodiment 2, 3, and 4.

### DETAILED DESCRIPTION OF THE PREFERRED EMBODIMENTS

The low temperature cofired ceramic materials in the present invention uses AlN powder as the major material along with the Borosilicate low melting point glass and proper sintering aids added into, so that the low temperature sintered AlN/glass composite material has been fabricated at the temperature of 750˜900° C.

Through the design of materials composition, comprehensive properties of the multi-phase materials can be improved, and thus the material's thermal conductivity can be enhanced to 11 W/m.K, the low dielectric constant 4.5-7 (room temp.: 1 MHZ) can be obtained, and the thermal expansion coefficient is controlled under 5-10×10-6/K, which can meet the requirement of high density packaging.

On the basis of the softening temperature of low melting point Borosilicate glass drew into the multi-phase materials and the wetting properties of AlN powder, the present invention adopts the unique low temperature sintering technology. Under the combined action of pressure and liquid state viscous flow, the density of multi-phase materials with 50˜80 wt % AlN can be achieved under the temperature of 1000° C. within 2 hours. Also, relevant technology such as tape casting and metal wiring has also been analyzed. This lays the foundation for the application of AlN/glass composite substrate materials into the low temperature cofired technology.

The present invention uses AlN as the low temperature cofired ceramic material. AlN has a Wurtzite structure and good thermal conductivity (167-223 W/m° C.) and lower dielectric constant (about 8.8) compared with Al2O3. Moreover, it has thermal expansion coefficient (4.5×10-6/° C.) and density (3.21 gm/cm3) similar to silicon (Si). AlN is compatible with a variety of thin/thick film metallization process, and thus it is widely applied to electronic packaging. After using the carbonthermic reduction or Al direct nitridation reaction to form AlN powder; then, said substrate materials are fabricated through the process of hot pressing or pressureless sintering. During the sintering process, the contents of oxygen and impurity elements should be carefully controlled to prevent the loss of AlN's thermal conductivity.

Upon application, copper can be used as the thick film conductive metal in order to remove the residual carbon formed by sintering organic ingredients and in order not to affect the ceramic substrate's electrical characteristic.

In the low temperature cofired process, the thermal treatment condition depends on the selection of furnace atmosphere and the type of thick film metal. When gold or silver paste is used, organic ingredients must be burnt out for an hour at 350° C. Then, the temperature should be raised to 850° C. for 30 min. to achieve sintering. The cofired process can be undergone in the air. If the copper paste is used, organic ingredients can be burnt out in the air and the heating condition is 550° C., 5˜6 hours. Since the copper paste is actually fabricated by blending CuO and organic ingredients, thermal treatment should be first conducted under the atmosphere of mixed N/H or CO/CO2 at the temperature of 300˜400° C. for 30 min. to reduce CuO. Then, thermal treatment is conducted under the nitrogen atmosphere at the temperature of 750˜850° C. for 20˜30 min. so that sintering is achieved.

### Embodiment 1

After the 45% wt. glass powders and 55% wt. AlN have been uniformly mixed in the low temperature cofired ceramic materials with high thermal conductivity coefficient in an embodiment of the present invention, the proper forming method such as scraper forming is used to form a ceramic green tape (about 1.5 mm). Then, a trimming tool is used to trim the tape into a proper size. Sintering is then conducted at the temperature of 800° C. for 60 min., and thus a dense ceramic film can be obtained.

<Contrast 1>

After the 45% wt. glass powder and 55% wt. typical LTCC filler such as Al2O3 have been uniformly mixed in the conventional low temperature cofired ceramic materials, the proper forming method such as scraper forming is used to form a ceramic green tape (about 1.5 mm). Then, a trimming tool is used to trim the tape into a proper size. Sintering is then conducted at the temperature of 800° C. for 60 min., and thus a dense ceramic film can be obtained.

<Conclusion 1>

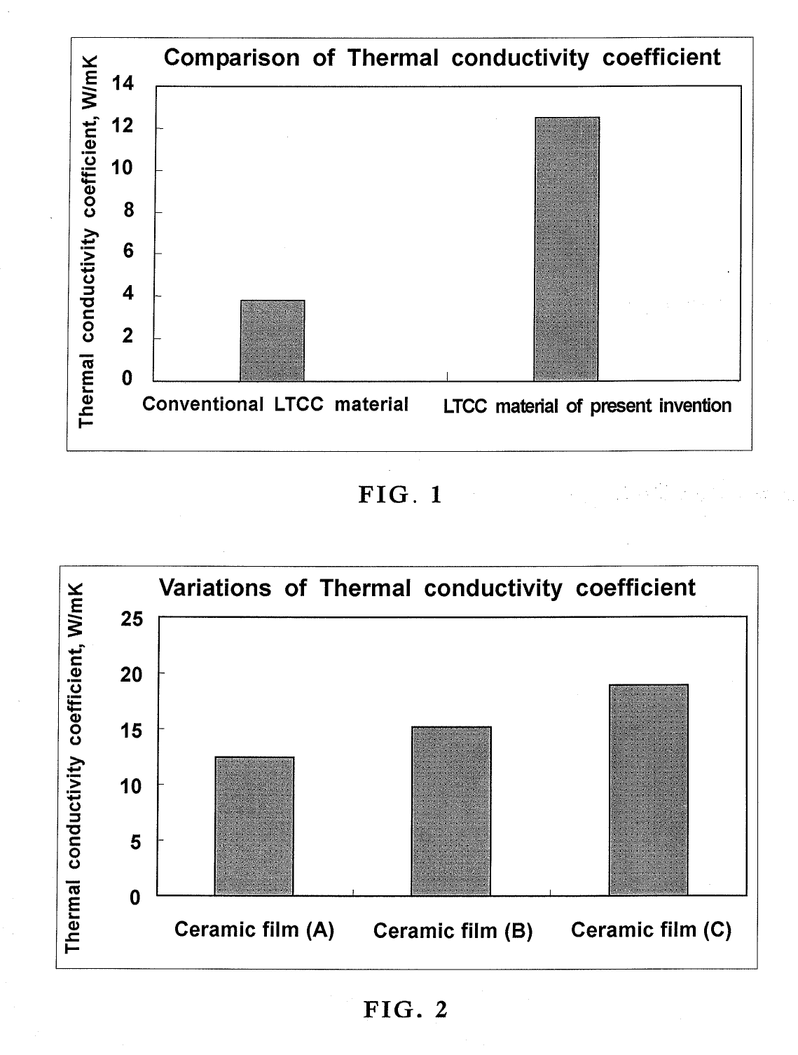

When measuring the thermal conductivity coefficient of ceramic films in embodiment 1 and contrast 1, the results have been shown in FIG. 1 that the thermal conductivity coefficient of the sintered ceramic film in the low temperature cofired ceramic materials obtained in embodiment 1 is 12.5 w/mk, while the thermal conductivity coefficient of the sintered ceramic film in the conventional low temperature cofired ceramic materials is merely 3.8 w/mk.

### Embodiment 2

After the 45% wt. glass powders and 55% wt. AlN have been uniformly mixed in the low temperature cofired ceramic materials with high thermal conductivity coefficient in another embodiment of the present invention, the proper forming method such as scraper forming is used to form a ceramic green tape (about 1.5 mm). Then, a trimming tool is used to trim the tape into a proper size. Sintering is then conducted at the temperature of 800° C. for 60 min., and thus a dense ceramic film (A) can be obtained.

### Embodiment 3

After the 40% wt. glass powders and 60% wt. AlN have been uniformly mixed in the low temperature cofired ceramic materials with high thermal conductivity coefficient in another embodiment of the present invention, the proper forming method such as scraper forming is used to form a ceramic green tape (about 1.5 mm). Then, a trimming tool is used to trim the tape into a proper size. Sintering is then conducted at the temperature of 800° C. for 60 min., and thus a dense ceramic film (B) can be obtained.

### Embodiment 4

After the 35% wt.glass powders and 65% wt. AlN have been uniformly mixed in the low temperature cofired ceramic materials with high thermal conductivity coefficient in another embodiment of the present invention, the proper forming method such as scraper forming is used to form a ceramic green tape (about 1.5 mm). Then, a trimming tool is used to trim the tape into a proper size. Sintering is then conducted at the temperature of 800° C. for 60 min., and thus a dense ceramic film (C) can be obtained.

<Conclusion 2 >

When measuring the thermal conductivity coefficient of three ceramic films obtained from embodiment 2, 3 and 4, the results are that When there are more AlN, the thermal conductivity coefficient will be higher (as shown in FOG. 2).

As described above, the low temperature cofired ceramic materials in the present invention has not yet been made public, which is consistent with relevant Innovation Patent Low.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A low temperature cofired ceramic materials, which is characterized in: low temperature cofired ceramic materials which mainly comprise high conductivity ceramic materials (i.e. AlN, BeO, SiC, etc.) and Borosilicate powder glass materials.

2. The low temperature cofired ceramic materials as claimed in claim 1, wherein high conductivity ceramic materials (AlN) and Borosilicate powder glass materials are mixed evenly.

3. The low temperature cofired ceramic materials as claimed in claim 1, wherein AlN's high thermal conductivity is 50˜80 wt % AlN mixed with 30˜50 wt % glass materials.

4. The low temperature cofired ceramic materials as claimed in claim 1, wherein an appropriate amount of solvent is added.

5. The low temperature cofired ceramic materials as claimed in claim 1, wherein proper amount of sintering aids or plasticizers are added.
